(19) United States
(12) Patent Application Publication
(10) Pub. No.: US 2026/0370802 A1
(43) Pub. Date: Nov. 19, 2026

(54) Methods and Apparatus of Merge List with Constrained for Cross-component Model Candidates in Video Coding

(71) Applicant: MEDIATEK INC., Hsinchu City (TW)

(72) Inventors: Chia-Ming TSAI, Hsinchu City (TW); Tzu-Der CHUANG, Hsinchu City (TW); Hsin-Yi TSENG, Hsinchu City (TW); Cheng-Yen CHUANG, Hsinchu City (TW); Ching-Yeh CHEN, Hsinchu City (TW); Chih-Wei HSU, Hsinchu City (TW); Yi-Wen CHEN, San Jose, CA (US)

(21) Appl. No.: 19/155,357

(22) PCT Filed: Feb. 18, 2024
(86) PCT No.: PCT/CN2024/077432

§ 371 Date: Aug. 11, 2025

Related U.S. Application Data
(60) Provisional application No. 63/485,564, filed on Feb. 17, 2023.
(60) Provisional application No. 63/491,089, filed on Mar. 20, 2023.

(51) Int. Cl. H04N 19/105; H04N 19/176; H04N 19/186

(52) U.S. Cl. CPC H04N 19/105; H04N 19/176; H04N 19/186

(57) ABSTRACT

Method and apparatus for adding a CCM candidate to a history table or merge list. According to the method, a merge list or a history table is derived. Whether to add a target CCM candidate to a merge list or a history table is determined based on one or more conditions, wherein said one or more conditions comprise one or more similarities calculated between the target CCM candidate and one or more member candidates respectively, and said one or more member candidates are in the merge list or the history table. The second-colour block is encoded or decoded using information comprising the merge list or the history table, wherein when the target CCM candidate is selected for the current block, a predictor for the second-colour block is generated by applying a target cross-component model associated with the target CCM candidate to reconstructed first-colour block.

### CROSS REFERENCE TO RELATED APPLICATIONS

The present invention is a non-Provisional Application of and claims priority to U.S. Provisional Patent Application No. 63/485,564, filed on Feb. 17, 2023 and U.S. Provisional Patent Application No. 63/491,089, filed on Mar. 20, 2023. The U.S. Provisional Patent Applications are hereby incorporated by reference in their entireties.

### FIELD OF THE INVENTION

The present invention relates to video coding system. In particular, the present invention relates to adding cross-component model candidates into a history table or merge list and constraints on the number of candidates in the history table or merge list in a video coding system.

### BACKGROUND

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology-Coded representation of immersive media-Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video encoding system incorporating loop processing. For Intra Prediction 110, the prediction data is derived based on previously coded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter-Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

According to VVC, an input picture is partitioned into non-overlapped square block regions referred as CTUs (Coding Tree Units), similar to HEVC. Each CTU can be partitioned into one or multiple smaller size coding units (CUs). The resulting CU partitions can be in square or rectangular shapes. Also, VVC divides a CTU into prediction units (PUs) as a unit to apply prediction process, such as Inter prediction, Intra prediction, etc.

The VVC standard incorporates various new coding tools to further improve the coding efficiency over the HEVC standard. Some new tools relevant to the present invention are reviewed as follows.

In the present invention, methods and apparatus to improve the way to add a cross-component model candidate to a history table of merge list are disclosed. In addition, methods and apparatus to pose constraints on the maximum number of to-be-added candidates to the history table of merge list are disclosed.

### BRIEF SUMMARY OF THE INVENTION

A method and apparatus for adding cross-component model candidates to a history table of merge list based on similarity are disclosed. According to the method, input data associated with a current block comprising a first-colour block and a second-colour block are received, wherein the input data comprise pixel data to be encoded at an encoder side or data associated with the current block to be decoded at a decoder side. A merge list or a history table is derived. Whether to add a target CCM candidate to the merge list or the history table is determined based on one or more conditions, wherein said one or more conditions comprise one or more similarities calculated between the target CCM candidate and one or more member candidates respectively, and said one or more member candidates are in the merge list or the history table. The second-colour block is encoded or decoded using information comprising the merge list or the history table, wherein when the target CCM candidate is selected for the current block, a predictor for the second-colour block is generated by applying a target cross-component model associated with the target CCM candidate to reconstructed first-colour block.

In one embodiment, said one or more similarities are calculated based on one or more model parameters. In one embodiment, part of said one or more model parameters are used for calculating said one or more similarities. In one embodiment, the target CCM candidate corresponds to a CCLM candidate with a scale and one or more offset parameters, and said one or more similarities are measured based on the scale or based on said one or more offset parameters. In one embodiment, the target CCM candidate corresponds to a CCCM candidate with c0 to c6 parameters, and said one or more similarities are measured based on only n parameters and n is less than 7.

In one embodiment, said one or more similarities are calculated based on one or more model errors. In one embodiment, the target cross-component model associated with the CCM candidate is applied to neighbouring reconstructed first-colour samples of the current block to derive a target model error associated with the CCM candidate, and the target model error is compared with one or more member model errors associated with said one or more member candidates.

In one embodiment, a maximum number of to-be-added candidates associated with a specific coding mode in the merge list or the history table is constrained to be k, and the k is a positive integer. For example, the to-be-added candidates associated with the specific coding mode correspond to spatial adjacent candidates or the to-be-added candidates with the specific coding mode correspond to non-spatial adjacent candidates. For another example, the to-be-added candidates associated with the specific coding mode are from the history table. For yet another example, the to-be-added candidates associated with the specific coding mode have a cross-component prediction model derived from neighbouring reconstruction samples of the current block. In one embodiment, the k depends on current block size, prediction mode of one or more neighbouring blocks, slice type, temporal identifier, maximum allowed number of said one or more member candidates, or a combination thereof.

In one embodiment, whether said one or more member candidates are allowed to be reordered or not depends on a model type or coding mode associated with said one or more member candidates. For example, when said one or more member candidates correspond to spatial adjacent candidates or said one or more member candidates correspond to non-spatial adjacent candidates, said one or more member candidates are allowed to be reordered. For another example, when said one or more member candidates correspond to spatial adjacent candidates or non-spatial adjacent candidates, said one or more member candidates are allowed to be reordered. For yet another example, when said one or more member candidates are from the history table, said one or more member candidates are allowed to be reordered. For yet another example, when said one or more member candidates are associated with a cross-component prediction model derived from neighbouring reconstruction samples of the current block, said one or more member candidates are not allowed to be reordered.

### BRIEF DESCRIPTION OF THE DRAWINGS

FIG. 1A illustrates an exemplary adaptive Inter/Intra video coding system incorporating loop processing.

FIG. 1B illustrates a corresponding decoder for the encoder in FIG. 1A.

FIG. 2 illustrates examples of a multi-type tree structure corresponding to vertical binary splitting (SPLIT_BT_VER), horizontal binary splitting (SPLIT_BT_HOR), vertical ternary splitting (SPLIT_TT_VER), and horizontal ternary splitting (SPLIT_TT_HOR).

FIG. 3 shows the intra prediction modes as adopted by the VVC video coding standard.

FIG. 4 shows an example of the location of the left and above samples and the sample of the current block involved in the LM_LA mode.

FIG. 5 shows an example of classifying the neighbouring samples into two groups.

FIG. 6A illustrates an example of the CCLM model.

FIG. 6B illustrates an example of the effect of the slope adjustment parameter “u” for model update.

FIG. 7 illustrates an example of spatial part of the convolutional filter.

FIG. 8 illustrates an example of reference area with paddings used to derive the filter coefficients.

FIG. 9 illustrates the 16 gradient patterns for Gradient Linear Model (GLM).

FIG. 10 illustrates the neighbouring blocks used for deriving spatial merge candidates for VVC.

FIG. 11 illustrates the possible candidate pairs considered for redundancy check in VVC.

FIG. 12 illustrates an example of temporal candidate derivation, where a scaled motion vector is derived according to POC (Picture Order Count) distances.

FIG. 13 illustrates the position for the temporal candidate selected between candidates C₀ and C₁.

FIG. 14 illustrates an exemplary pattern of the non-adjacent spatial merge candidates.

FIG. 15 illustrates examples of CCM information propagation, where the blocks with dash line (i.e., A, E, G) are coded in cross-component mode (e.g., CCLM, MMLM, GLM, CCCM).

FIG. 16 illustrates an example of neighbouring templates for calculating model error.

FIG. 17 illustrates a flowchart of an exemplary video coding system that adds a cross-component model candidate to a history table of merge list based on similarity according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

### Partitioning of the CTUs Using a Tree Structure

In HEVC, a CTU is split into CUs by using a quaternary-tree (QT) structure denoted as coding tree to adapt to various local characteristics. The decision whether to code a picture area using inter-picture (temporal) or intra-picture (spatial) prediction is made at the leaf CU level. Each leaf CU can be further split into one, two or four Pus according to the PU splitting type. Inside one PU, the same prediction process is applied and the relevant information is transmitted to the decoder on a PU basis. After obtaining the residual block by applying the prediction process based on the PU splitting type, a leaf CU can be partitioned into transform units (TUs) according to another quaternary-tree structure similar to the coding tree for the CU. One of key feature of the HEVC structure is that it has the multiple partition conceptions including CU, PU, and TU.

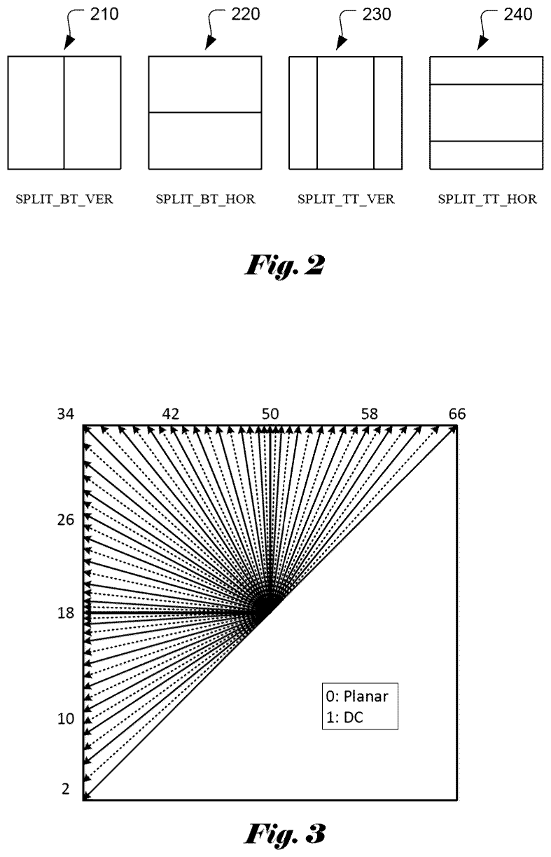

In VVC, a quadtree with nested multi-type tree using binary and ternary splits segmentation structure replaces the concepts of multiple partition unit types, i.e. it removes the separation of the CU, PU and TU concepts except as needed for CUs that have a size too large for the maximum transform length, and supports more flexibility for CU partition shapes. In the coding tree structure, a CU can have either a square or rectangular shape. A coding tree unit (CTU) is first partitioned by a quaternary tree (a.k.a. quadtree) structure. Then the quaternary tree leaf nodes can be further partitioned by a multi-type tree structure. As shown in FIG. 2, there are four splitting types in multi-type tree structure, vertical binary splitting (SPLIT_BT_VER 210), horizontal binary splitting (SPLIT_BT_HOR 220), vertical ternary splitting (SPLIT_TT_VER 230), and horizontal ternary splitting (SPLIT_TT_HOR 240). The multi-type tree leaf nodes are called coding units (CUs), and unless the CU is too large for the maximum transform length, this segmentation is used for prediction and transform processing without any further partitioning. This means that, in most cases, the CU, PU and TU have the same block size in the quadtree with nested multi-type tree coding block structure. The exception occurs when maximum supported transform length is smaller than the width or height of the colour component of the CU.

Intra Mode Coding with 67 Intra Prediction Modes

To capture the arbitrary edge directions presented in natural video, the number of directional intra modes in VVC is extended from 33, as used in HEVC, to 65. The new directional modes not in HEVC are depicted as red dotted arrows in FIG. 3, and the planar and DC modes remain the same. These denser directional intra prediction modes apply for all block sizes and for both luma and chroma intra predictions.

In VVC, several conventional angular intra prediction modes are adaptively replaced with wide-angle intra prediction modes for the non-square blocks.

### Cross-Component Linear Model (CCLM) Prediction

To reduce the cross-component redundancy, a cross-component linear model (CCLM) prediction mode is used in the VVC, for which the chroma samples are predicted based on the reconstructed luma samples of the same CU by using a linear model as follows:

pred_{C}(i,j)=α·rec_{L}′(i,j)+β, (1)

where pred_{C}(i,j) represents the predicted chroma samples in a CU and rec_{L}′ (i,j) represents the downsampled reconstructed luma samples of the same CU.

The CCLM parameters (α and β) are derived with at most four neighbouring chroma samples and their corresponding down-sampled luma samples. Suppose the current chroma block dimensions are W×H, then W′ and H′ are set as
W′=W, H′=H when LM_LA mode is applied;
W′=W+H when LM_A mode is applied;
H′=H+W when LM_L mode is applied.

The above neighbouring positions are denoted as S[0, −1] . . . S[W′−1, −1] and the left neighbouring positions are denoted as S[−1, 0] . . . S[−1, H′−1]. Then the four samples are selected as
S[W′/4,−1],S[3*W′/4,−1],S[−1,H′/4],S[−1,3*H′/4] when LM_LA mode is applied and both above and left neighbouring samples are available;
S[W′/8,−1],S[3*W′/8,−1],S[5*W′/8,−1],S[7*W′/8,−1] when LM_A mode is applied or only the above neighbouring samples are available;
S[−1,H′/8],S[−1,3*H′/8],S[−1, 5*H′/8],S[−1,7*H′/8] when LM_L mode is applied or only the left neighbouring samples are available.

The four neighbouring luma samples at the selected positions are down-sampled and compared four times to find two larger values: x⁰_{A} and X¹_{A}, and two smaller values: X⁰_{B} and x¹_{B}. Their corresponding chroma sample values are denoted as y⁰_{A}, y¹_{A}, y⁰_{B} and y¹_{B}. Then x_{A}, x_{B}, y_{A} and y_{B} are derived as:

Xa=(x0A+x1A+1)>>1;

Xb=(x0B+x1B+1)>>1;

Ya=(y0A+y1A+1)>>1;

Yb=(y0B+y1B+1)>>1 (2)

Finally, the linear model parameters α and β are obtained according to the following equations.

$$α = \frac{{Y}_{a} - {Y}_{b}}{{X}_{a} - {X}_{b}} \qquad ( 3 )$$

$$β = {Y}_{b} - α \cdot {X}_{b} \qquad ( 4 )$$

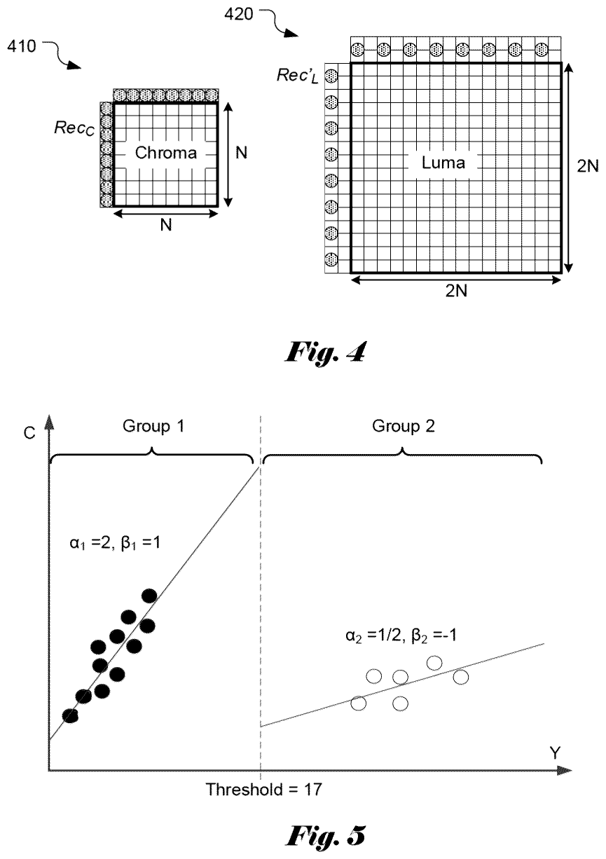

FIG. 4 shows an example of the location of the left and above samples and the sample of the current block involved in the LM_LA mode. FIG. 4 shows the relative sample locations of N×N chroma block 410, the corresponding 2N×2N luma block 420 and their neighbouring samples (shown as filled circles).

The division operation to calculate parameter a is implemented with a look-up table. To reduce the memory required for storing the table, the diff value (difference between maximum and minimum values) and the parameter a are expressed by an exponential notation. For example, diff is approximated with a 4-bit significant part and an exponent. Consequently, the table for 1/diff is reduced into 16 elements for 16 values of the significand as follows:

DivTable[ ]={0,7,6,5,5,4,4,3,3,2,2,1,1,1,1,0} (5)

This would have a benefit of both reducing the complexity of the calculation as well as the memory size required for storing the needed tables.

Besides the above template and left template can be used to calculate the linear model coefficients together, they also can be used alternatively in the other 2 LM modes, called LM_A, and LM_L modes.

In LM_A mode, only the above template is used to calculate the linear model coefficients. To get more samples, the above template is extended to (W+H) samples. In LM_L mode, only left template are used to calculate the linear model coefficients. To get more samples, the left template is extended to (H+W) samples.

In LM_LA mode, left and above templates are used to calculate the linear model coefficients.

To match the chroma sample locations for 4:2:0 video sequences, two types of down-sampling filter are applied to luma samples to achieve 2 to 1 down-sampling ratio in both horizontal and vertical directions. The selection of down-sampling filter is specified by a SPS level flag. The two down-sampling filters are as follows, which are corresponding to “type-0” and “type-2” content, respectively.

Rec_{L}′(i,j)=[rec_{L}(2i−1,2j−1)+2·rec_{L}(2i−1,2j−1)+rec_{L}(2i+1,2j−1)+rec_{L}(2i−1,2j)+2·rec_{L}(2i,2j)+rec_{L}(2i+1,2j)+4]>>3 (6)

Rec_{L}′(i,j)=rec_{L}(2i,2j−1)+rec_{L}(2i−1,2j)+4·rec_{L}(2i,2j)+rec_{L}(2i+1,2j)+rec_{L}(2i,2j+1)+4]>>3 (7)

Note that only one luma line (general line buffer in intra prediction) is used to make the down-sampled luma samples when the upper reference line is at the CTU boundary.

This parameter computation is performed as part of the decoding process, and is not just as an encoder search operation. As a result, no syntax is used to convey the a and p values to the decoder.

For chroma intra mode coding, a total of 8 intra modes are allowed for chroma intra mode coding. Those modes include five traditional intra modes and three cross-component linear model modes (LM_LA, LM_A, and LM_L). In addition, chroma mode coding directly depends on the intra prediction mode of the corresponding luma block. Since separate block partitioning structure for luma and chroma components is enabled in I slices, one chroma block may correspond to multiple luma blocks. Therefore, for Chroma DM mode, the intra prediction mode of the corresponding luma block covering the centre position of the current chroma block is directly inherited.

### Multiple Model CCLM (MMLM)

In the JEM (J. Chen, E. Alshina, G. J. Sullivan, J.-R. Ohm, and J. Boyce, Algorithm Description of Joint Exploration Test Model 7, document JVET-G1001, ITU-T/ISO/IEC Joint Video Exploration Team (JVET), July 2017), multiple model CCLM mode (MMLM) is proposed for using two models for predicting the chroma samples from the luma samples for the whole CU. In MMLM, neighbouring luma samples and neighbouring chroma samples of the current block are classified into two groups, each group is used as a training set to derive a linear model (i.e., a particular a and p are derived for a particular group). Furthermore, the samples of the current luma block are also classified based on the same rule for the classification of neighbouring luma samples. Three MMLM model modes (MMLM_LA, MMLM_T, and MMLM_L) are allowed for choosing the neighbouring samples from left-side and above-side, above-side only, and left-side only, respectively.

FIG. 5 shows an example of classifying the neighbouring samples into two groups. Threshold is calculated as the average value of the neighbouring reconstructed luma samples. A neighbouring sample with Rec′_{L}[x,y]<=Threshold is classified into group 1; while a neighbouring sample with Rec′_{L}[x,y]>Threshold is classified into group 2.

$$\{ \begin{matrix}{Pred}_{C} [ x , y ] = {α}_{1} \times {Rec}_{L}^{′} [ x , y ] + {β}_{1} & if {Rec}_{L}^{′} [ x , y ] \leq Threshold \\ {Pred}_{C} [ x , y ] = {α}_{2} \times {Rec}_{L}^{′} [ x , y ] + {β}_{2} & if {Rec}_{L}^{′} [ x , y ] > Threshold\end{matrix} \qquad ( 8 )$$

Accordingly, the MMLM uses two models according to the sample level of the neighbouring samples.

### Slope Adjustment of CCLM

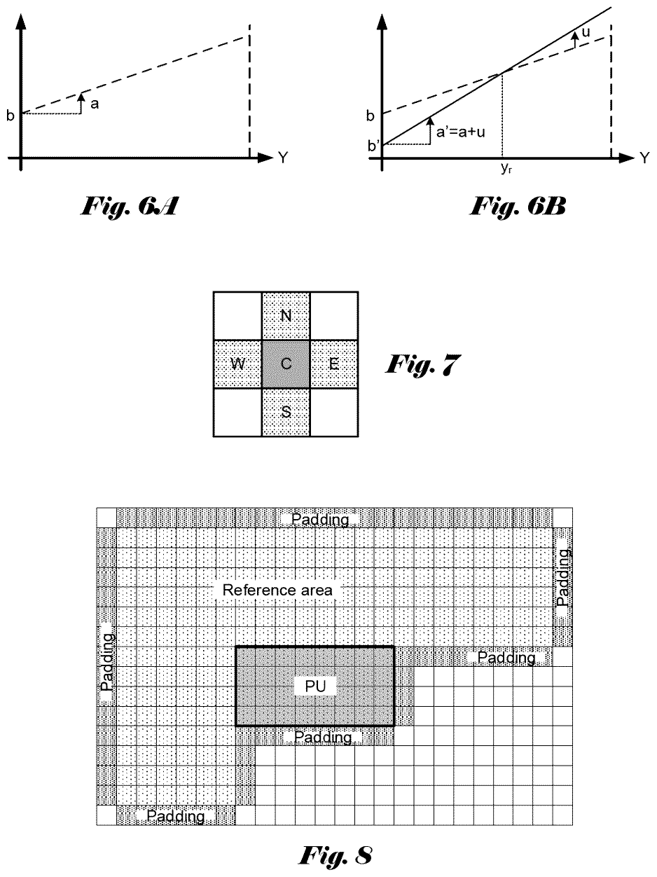

CCLM uses a model with 2 parameters to map luma values to chroma values as shown in FIG. 6A. The slope parameter “a” and the bias parameter “b” define the mapping as follows:

chromaVal=a*lumaVal+b

An adjustment “u” to the slope parameter is signalled to update the model to the following form, as shown in FIG. 6B:

chromaVal=a′*lumaVal+b′

where

a′=a+u,

b′=b−u*yr.

With this selection, the mapping function is tilted or rotated around the point with luminance value yᵣ. The average of the reference luma samples used in the model creation as yᵣ in order to provide a meaningful modification to the model. FIGS. 6A and 6B illustrates the process.

### Local Illumination Compensation (LIC)

Local Illumination Compensation (LIC) is a method to do inter predict by using neighbour samples of current block and reference block. It is based on a linear model using a scaling factor a and an offset b. It derives a scaling factor a and an offset b by referring to the neighbour samples of current block and reference block. Moreover, it's enabled or disabled adaptively for each CU.

For more detail for LIC, it can refer to the document JVET-C1001 (Jianle Chen, et al., “Algorithm Description of Joint Exploration Test Model 3”, Joint Video Exploration Team (JVET) of ITU-T SG 16 WP 3 and ISO/IEC JTC 1/SC 29/WG 11, 3rd Meeting: Geneva, CH, 26 May-1 Jun. 2016, Document: JVET-C1001).

### Convolutional Cross-Component Model (CCCM)

In CCCM, a convolutional model is applied to improve the chroma prediction performance. The convolutional model has 7-tap filter consisting of a 5-tap plus sign shape spatial component, a nonlinear term and a bias term. The input to the spatial 5-tap component of the filter consists of a centre (C) luma sample which is collocated with the chroma sample to be predicted and its above/north (N), below/south (S), left/west (W) and right/east (E) neighbours as shown in FIG. 7.

The nonlinear term (denoted as P) is represented as power of two of the centre luma sample C and scaled to the sample value range of the content:

P=(C*C+midVal)>>bitDepth.

For example, for 10-bit contents, the nonlinear term is calculated as:

P=(C*C+512)>>10

The bias term (denoted as B) represents a scalar offset between the input and output (similarly to the offset term in CCLM) and is set to the middle chroma value (512 for 10-bit content).

Output of the filter is calculated as a convolution between the filter coefficients ci and the input values and clipped to the range of valid chroma samples:

predChromaVal=c₀C+c₁N+c₂S+c₃E+c₄W+c₅P+c₆B

The filter coefficients ci are calculated by minimising MSE between predicted and reconstructed chroma samples in the reference area. FIG. 8 illustrates an example of the reference area which consists of 6 lines of chroma samples above and left of the PU. Reference area extends one PU width to the right and one PU height below the PU boundaries. Area is adjusted to include only available samples. The extensions to the area (indicated as “paddings”) are needed to support the “side samples” of the plus-shaped spatial filter in FIG. 11 and are padded when in unavailable areas.

The MSE minimization is performed by calculating autocorrelation matrix for the luma input and a cross-correlation vector between the luma input and chroma output. Autocorrelation matrix is LDL decomposed and the final filter coefficients are calculated using back-substitution. The process follows roughly the calculation of the ALF filter coefficients in ECM, however LDL decomposition was chosen instead of Cholesky decomposition to avoid using square root operations.

Also, similarly to CCLM, there is an option of using a single model or multi-model variant of CCCM. The multi-model variant uses two models, one model derived for samples above the average luma reference value and another model for the rest of the samples (following the spirit of the CCLM design). Multi-model CCCM mode can be selected for PUs which have at least 128 reference samples available.

### Gradient Linear Model (GLM)

Compared with the CCLM, instead of down-sampled luma values, the GLM utilizes luma sample gradients to derive the linear model. Specifically, when the GLM is applied, the input to the CCLM process, i.e., the down-sampled luma samples L, are replaced by luma sample gradients G. The other parts of the CCLM (e.g., parameter derivation, prediction sample linear transform) are kept unchanged.

C=α·G+β

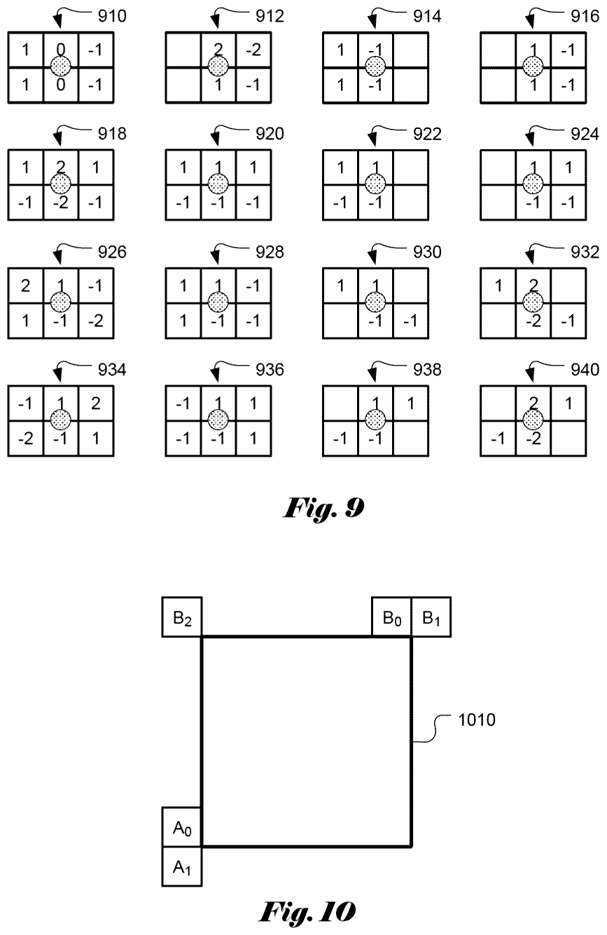

For signalling, when the CCLM mode is enabled for the current CU, two flags are signalled separately for Cb and Cr components to indicate whether GLM is enabled for each component. If the GLM is enabled for one component, one syntax element is further signalled to select one of 16 gradient filters (910-940 in FIG. 9) for the gradient calculation. The GLM can be combined with the existing CCLM by signalling one extra flag in bitstream. When such combination is applied, the filter coefficients that are used to derive the input luma samples of the linear model are calculated as the combination of the selected gradient filter of the GLM and the down-sampling filter of the CCLM.

### Spatial Candidate Derivation

The derivation of spatial merge candidates in VVC is the same as that in HEVC except that the positions of first two merge candidates are swapped. A maximum of four merge candidates (B₀, A₀, B₁ and A₁) for current CU 1010 are selected among candidates located in the positions depicted in FIG. 10. The order of derivation is B₀, A₀, B₁, A₁ and B₂. Position B₂ is considered only when one or more neighbouring CU of positions B₀, A₀, B₁, A₁ are not available (e.g. belonging to another slice or tile) or is intra coded. After candidate at position A₁ is added, the addition of the remaining candidates is subject to a redundancy check which ensures that candidates with the same motion information are excluded from the list so that coding efficiency is improved. To reduce computational complexity, not all possible candidate pairs are considered in the mentioned redundancy check. Instead, only the pairs linked with an arrow in FIG. 11 are considered and a candidate is only added to the list if the corresponding candidate used for redundancy check does not have the same motion information.

### Temporal Candidates Derivation

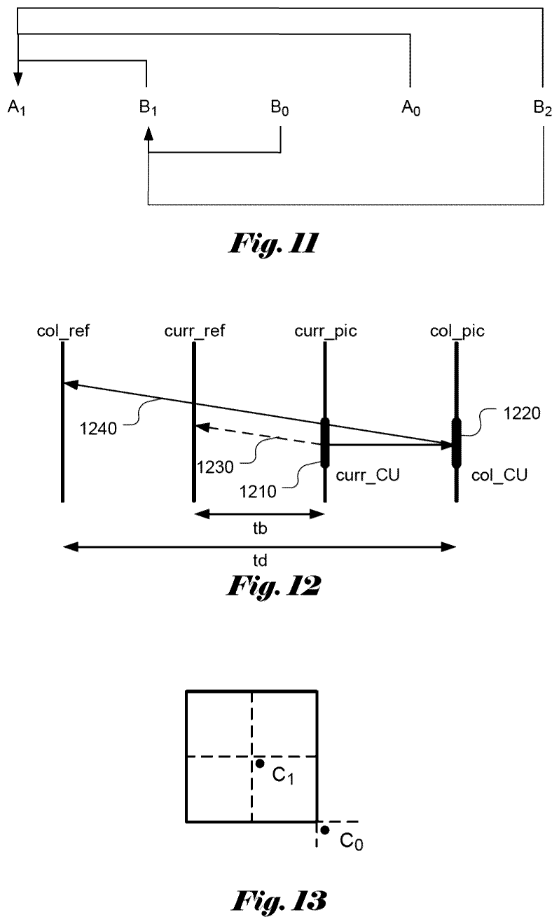

In this step, only one candidate is added to the list. Particularly, in the derivation of this temporal merge candidate for a current CU 1210, a scaled motion vector is derived based on the co-located CU 1220 belonging to the collocated reference picture as shown in FIG. 12. The reference picture list and the reference index to be used for the derivation of the co-located CU is explicitly signalled in the slice header. The scaled motion vector 1230 for the temporal merge candidate is obtained as illustrated by the dotted line in FIG. 12, which is scaled from the motion vector 1240 of the co-located CU using the POC (Picture Order Count) distances, tb and td, where tb is defined to be the POC difference between the reference picture of the current picture and the current picture and td is defined to be the POC difference between the reference picture of the co-located picture and the co-located picture. The reference picture index of temporal merge candidate is set equal to zero.

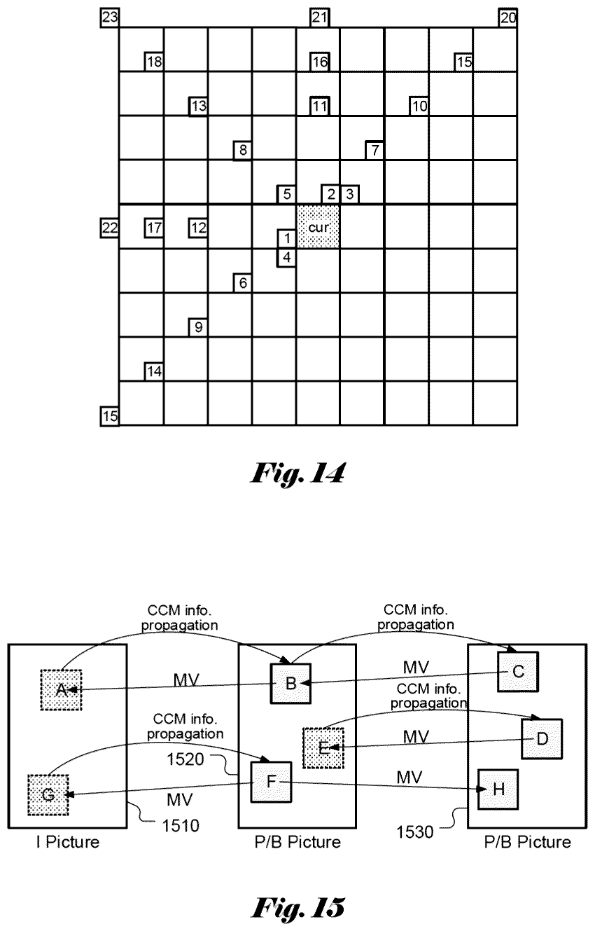

The position for the temporal candidate is selected between candidates C₀ and C₁, as depicted in FIG. 13. If CU at position C₀ is not available, is intra coded, or is outside of the current row of CTUs, position C₁ is used. Otherwise, position C₀ is used in the derivation of the temporal merge candidate.

### Non-Adjacent Spatial Candidate

During the development of the VVC standard, a coding tool referred as Non-Adjacent Motion Vector Prediction (NAMVP) has been proposed in JVET-L0399 (Yu Han, et al., “CE4.4.6: Improvement on Merge/Skip mode”, Joint Video Exploration Team (JVET) of ITU-T SG 16 WP 3 and ISO/IEC JTC 1/SC 29/WG 11, 12th Meeting: Macao, CN, 3-12 Oct. 2018, Document: JVET-L0399). According to the NAMVP technique, the non-adjacent spatial merge candidates are inserted after the TMVP (i.e., the temporal MVP) in the regular merge candidate list. The pattern of spatial merge candidates is shown in FIG. 14. The distances between non-adjacent spatial candidates and current coding block are based on the width and height of current coding block. In FIG. 14, each small square corresponds to a NAMVP candidate and the order of the candidates (as shown by the number inside the square) are related to the distance. The line buffer restriction is not applied. In other words, the NAMVP candidates far away from a current block may have to be stored that may require a large buffer.

### Cross-Component Prediction (CCP) Merge Mode

For chroma coding, a flag is signalled to indicate whether CCP mode (including the CCLM, CCCM, GLM and their variants) or non-CCP mode (conventional chroma intra prediction mode, fusion of chroma intra prediction mode) is used. If the CCP mode is selected, one more flag is signalled to indicate how to derive the CCP type and parameters, i.e., either from a CCP merge list or signalled/derived on-the-fly. A CCP merge candidate list is constructed from the spatial adjacent, temporal, spatial non-adjacent, history-based or shifted temporal candidates. After including these candidates, default models are further included to fill the remaining empty positions in the merge list. In order to remove redundant CCP models in the list, pruning operation is applied. After constructing the list, the CCP models in the list are reordered depending on the SAD costs, which are obtained using the neighbouring template of the current block. More details are described below.

### Spatial Adjacent and Non-Adjacent Candidates

The positions and inclusion order of the spatial adjacent and non-adjacent candidates are the same as those defined in ECM for regular inter merge prediction candidates.

### Temporal and Shifted Temporal Candidates

Temporal candidates are selected from the collocated picture. The position and inclusion order of the temporal candidates are the same as those defined in ECM for regular inter merge prediction candidates. The shifted temporal candidates are also selected from the collocated picture. The position of temporal candidates is shifted by a selected motion vector which is derived from motion vectors of neighbouring blocks.

### History-Based Candidates

A history-based table is maintained to include the recently used CCP models, and the table is reset at the beginning of each CTU row. If the current list is not full after including spatial adjacent and non-adjacent candidates, the CCP models in the history-based table are added into the list.

### Default Candidates

CCLM candidates with default scaling parameters are considered, only when the list is not full after including the spatial adjacent, spatial non-adjacent, or history-based candidates. If the current list has no candidates with the single model CCLM mode, the default scaling parameters are {0, 1/8, −1/8, 2/8, −2/8, 3/8, −3/8, 4/8, −4/8, 5/8, −5/8, 6/81. Otherwise, the default scaling parameters are {0, the scaling parameter of the first CCLM candidate+{1/8, −1/8, 2/8, −2/8, 3/8, −3/8, 4/8, −4/8, 5/8, −5/8, 6/811.

A flag is signalled to indicate whether the CCP merge mode is applied or not. If CCP merge mode is applied, an index is signalled to indicate which candidate model is used by the current block. In addition, CCP merge mode is not allowed for the current chroma coding block when the current CU is coded by intra sub-partitions (ISP) with single tree, or the current chroma coding block size is less than or equal to 16.

In order to improve the performance of cross-component prediction, methods and apparatus to add a cross-component model candidate to a history table of merge list based on similarity are disclosed.

### Guided Parameter Set for Refining the Cross-Component Model Parameters

According to this method, the guided parameter set is used to refine the derived model parameters by a specified CCLM mode. For example, the guided parameter set is explicitly signalled in the bitstream, after deriving the model parameters, the guided parameter set is added to the derived model parameters as the final model parameters. The guided parameter set contain at least one of a differential scaling parameter (dA), a differential offset parameter (dB), and a differential shift parameter (dS). For example, equation (1) can be rewritten as:

pred_{C}(i,j)=((α′−rec_{L}′(i,j))>>s)+β,
and if dA is signalled, the final prediction is:

pred_{C}(i,j)=(((α′+dA)·rec_{L}′(i,j))>>s)+β.

Similarly, if dB is signalled, then the final prediction is:

pred_{C}(i,j)=((α′·rec_{L}′(i,j))>>s)+(β+dB).

If dS is signalled, then the final prediction is:

pred_{C}(i,j)=((α′·rec_{L}′(i,j))>>(s+dS)+β.

If dA and dB are signalled, then the final prediction is:

pred_{C}(i,j)=(((α′+dA)·rec_{L}′(i,j)>>s)+(β+dB).

The guided parameter set can be signalled per colour component. For example, one guided parameter set is signalled for Cb component, and another guided parameter set is signalled for Cr component. Alternatively, one guided parameter set can be signalled and shared among colour components. The signalled dA and dB can be a positive or negative value. When signalling dA, one bin is signalled to indicate the sign of dA. Similarly, when signalling dB, one bin is signalled to indicate the sign of dB.

For another embodiment, if dA is signalled, dB can be implicitly derived from the average value of neighbouring (e.g. L-shape) reconstructed samples. For example, in VVC, four neighbouring luma and chroma reconstructed samples are selected to derived model parameters. Suppose the average value of neighbouring luma and chroma samples are lumaAvg and chromaAvg, then β is derived by β=chromaAvg−(α′+dA)·lumaAvg. The average value of neighbouring luma samples (i.e., lumaAvg) can be calculated by all selected luma samples, the luma DC mode value of the current luma CB, or the average of the maximum and minimum luma samples

$$( e . g . , lumaAvg = ( Max ( {x}_{A}^{0} , {x}_{A}^{1} ) + Min ( {x}_{B}^{0} , {x}_{B}^{1} ) + 1 ) ≫ 1 , or lumaAvg = ( Min ( {x}_{A}^{0} , {x}_{A}^{1} ) + Max ( {x}_{B}^{0} , {x}_{B}^{1} ) + 1 ) ≫ 1 ) .$$

Similarly, average value of neighbouring chroma samples (i.e., chromaAvg) can be calculated by all selected chroma samples, the chroma DC mode value of the current chroma CB, or the average of the maximum and minimum chroma samples

$$( e . g . , chromaAvg = ( Max ( {y}_{A}^{0} , {y}_{A}^{1} ) + Min ( {y}_{B}^{0} , {y}_{B}^{1} ) + 1 ) ≫ 1 , or chromaAvg = ( Min ( {y}_{A}^{0} , {y}_{A}^{1} ) + Max ( {y}_{B}^{0} , {y}_{B}^{1} ) + 1 ) ≫ 1 ) .$$

Note, for non-4:4:4 colour subsampling format, the selected neighbouring luma reconstructed samples can be from the output of CCLM downsampling process.

For another embodiment, the shift parameter, s, can be a constant value (e.g., s can be 3, 4, 5, 6, 7, or 8), and dS is equal to 0 and no need to be signalled.

For another embodiment, in MMLM, the guided parameter set can also be signalled per model. For example, one guided parameter set is signalled for one model and another guided parameter set is signalled for another model. Alternatively, one guided parameter set is signalled and shared among linear models. Or only one guided parameter set is signalled for one selected model, and another model is not further refined by guided parameter set.

### Inheriting Neighbouring Model Parameters for Refining the Cross-Component Model Parameters

The final scaling parameter of the current block is inherited from the neighbouring blocks and further refined by dA (e.g., dA derivation or signalling can be similar or the same as the method in the previous “Guided parameter set for refining the cross-component model parameters”). Once the final scaling parameter is determined, the offset parameter (e.g., p in CCLM) is derived based on the inherited scaling parameter and the average value of neighbouring luma and chroma samples of the current block. For example, if the final scaling parameter is inherited from a selected neighbouring block, and the inherited scaling parameter is α′ₙₑᵢ, then the final scaling parameter is (α′ₙₑᵢ+dA). For yet another embodiment, the final scaling parameter is inherited from a historical list and further refined by dA. For example, the historical list records the most recent j entries of final scaling parameters from previous CCLM-coded blocks. Then, the final scaling parameter is inherited from one selected entry of the historical list, α′ₙₑᵢ, and the final scaling parameter is (α′ₙₑᵢ+dA). For yet another embodiment, the final scaling parameter is inherited from a historical list or the neighbouring blocks, but only the MSB (Most Significant Bit) part of the inherited scaling parameter is taken, and the LSB (Least Significant Bit) of the final scaling parameter is from dA. For yet another embodiment, the final scaling parameter is inherited from a historical list or the neighbouring blocks, but does not further refine by dA.

For yet another embodiment, after inheriting model parameters, the offset can be further refined by dB. For example, if the final offset parameter is inherited from a selected neighbouring block, and the inherited offset parameter is β′ₙₑᵢ, then the final scaling parameter is (β′ₙₑᵢ+dB). For still another embodiment, the final offset parameter is inherited from a historical list and further refined by dB. For example, the historical list records the most recent j entries of final scaling parameters from previous CCLM-coded blocks. Then, the final scaling parameter is inherited from one selected entry of the historical list, β′ₗᵢₛₜ and the final scaling parameter is (β′ₗᵢₛₜ+dB).

For yet another embodiment, if the inherited neighbour block is coded with CCCM, the filter coefficients (cᵢ) are inherited. The offset parameter (e.g., c₆×B or c₆ in CCCM) can be re-derived based on the inherited parameter and the average value of neighbouring corresponding position luma and chroma samples of the current block. For still another embodiment, only partial filter coefficients are inherited (e.g., only n out of 6 filter coefficients are inherited, where 1≤n<6), the rest filter coefficients are further re-derived using the neighbouring luma and chroma samples of the current block.

For still another embodiment, if the inherited candidate applies GLM gradient pattern to its luma reconstructed samples, the current block shall also inherit the GLM gradient pattern of the candidate and apply to the current luma reconstructed samples.

For still another embodiment, if the inherited neighbour block is coded with multiple cross-component models (e.g., MMLM, or CCCM with multi-model), the classification threshold is also inherited to classify the neighbouring samples of the current block into multiple groups, and the inherited multiple cross-component model parameters are further assigned to each group. For yet another embodiment, the classification threshold is the average value of the neighbouring reconstructed luma samples, and the inherited multiple cross-component model parameters are further assigned to each group. Similarly, once the final scaling parameter of each group is determined, the offset parameter of each group is re-derived based on the inherited scaling parameter and the average value of neighbouring luma and chroma samples of each group of the current block. For another example, if CCCM with multi-model is used, once the final coefficient parameter of each group is determined (e.g., c₀ to c₅ except for c₆ in CCCM), the offset parameter (e.g., c₆×B or c₆ in CCCM) of each group is re-derived based on the inherited coefficient parameter and the neighbouring luma and chroma samples of each group of the current block.

For still another embodiment, inheriting model parameters may depend on the colour component. For example, Cb and Cr components may inherit model parameters or model derivation method from the same candidate or different candidates. For yet another example, only one of colour components inherits model parameters, and the other colour component derives model parameters based on the inherited model derivation method (e.g., if the inherit candidate is coded by MMLM or CCCM, the current block also derives model parameters based on MMLM or CCCM using the current neighbouring reconstructed samples). For still another example, only one of colour components inherits model parameters, and the other colour component derives its model parameters using the current neighbouring reconstructed samples.

For still another example, if Cb and Cr components can inherit model parameters or model derivation method from different candidates. The inherited model of Cr can depend on the inherited model of Cb. For example, possible cases include but not limited to (1) if the inherited model of Cb is CCCM, the inherited model of Cr shall be CCCM; (2) if the inherit model of Cb is CCLM, the inherit model of Cr shall be CCLM; (3) if the inherited model of Cb is MMLM, the inherited model of Cr shall be MMLM; (4) if the inherited model of Cb is CCLM, the inherited model of Cr shall be CCLM or MMLM; (5) if the inherited model of Cb is MMLM, the inherited model of Cr shall be CCLM or MMLM; (6) if the inherited model of Cb is GLM, the inherited model of Cr shall be GLM.

For yet another embodiment, after decoding a block, the (CCM) information cross-component model of the current block is derived and stored for later reconstruction process of neighbouring blocks using inherited neighbours model parameter. The CCM information mentioned in this disclosure includes but not limited to prediction mode (e.g., CCLM, MMLM, CCCM), GLM pattern index, model parameters, or classification threshold. For example, even the current block is coded by inter prediction, the cross-component model parameters of the current block can be derived by using the current luma and chroma reconstruction or prediction samples. Later, if another block is predicted by using inherited neighbours model parameters, it can inherit the model parameters from the current block. For another example, the current block is coded by cross-component prediction, the cross-component model parameters of the current block are re-derived by using the current luma and chroma reconstruction or prediction samples. For another example, the stored cross-component model can be CCCM, LM_LA (i.e., single model LM using both above and left neighbouring samples to derive model), or MMLM_LA (multi-model LM using both above and left neighbouring samples to derive model). For still example, even the current block is coded by non-cross-component intra prediction (e.g., DC, planar, intra angular modes, MIP, or ISP), the cross-component model parameters of the current block are derived by using the current luma and chroma reconstruction or prediction samples.

For another example, even the current block is coded by cross-component prediction, the cross-component model parameters of the current block are re-derived by using the current luma and chroma reconstruction or prediction samples. Later, the re-derived model parameters are combined with the original cross-component models, which is used in reconstructing the current block. For combining with the original cross-component models, it can use the model combination methods mentioned in the section entitled “Candidate List Construction”, or the section entitled “Inheriting Multiple Cross-Component Models”. For example, if the original cross-component model parameters are

$$\{ {c}_{0}^{0} , {c}_{1}^{0} , … , {c}_{M - 1}^{0} \} ,$$

and the re-derived cross-component model parameters are

$$\{ {c}_{0}^{0} , {c}_{1}^{0} , … , {c}_{M - 1}^{0} \} ,$$

then the final cross-component model is

$$\{ ( 1 - α ) \times {c}_{0}^{0} + α \times {c}_{0}^{1} , ( 1 - α ) \times {c}_{1}^{0} + α \times {c}_{1}^{1} , … , ( 1 - α ) \times {c}_{M - 1}^{0} + α \times {c}_{M - 1}^{1} \} ,$$

where α is a weighting factor. The weighting factor can be predefined or implicitly derived according to the neighbouring template cost.

For another embodiment, when inheriting a cross-component model from a neighbor merge candidate that was coded by a cross-component mode (e.g. CCLM and CCCM, . . . ), a flag can be signalled to indicate/select if the re-derived model is used. If the flag has a value equal to 0, the cross-component model used to encode the neighbour merge candidate is inherited. If the flag has a value equal to 1, the cross-component model re-derived based on the luma and chroma reconstruction or prediction samples of the neighbouring merge candidate is inherited.

For still another example, when the current slice is a non-intra slice (e.g., P slice or B slice), a cross-component model of the current block is derived and stored for later reconstruction process of neighbouring blocks using inherited neighbours model parameter. For still another embodiment, when the current block is inter-coded, the CCM information of the current inter-coded block is derived by copying the CCM information from its reference block that has CCM information in a reference picture, located by the motion information of the current inter-coded block. For example, as shown in FIG. 15, the block B in a P/B picture 1520 is inter-coded, then the CCM information of block B is obtained by copying CCM information from its referenced block A in an I picture 1510. It should be noted that the current block can also copy the CCM information from an intra-coded block in an P/B picture. For example, as shown in the FIG. 15, the block D in a P/B picture 1530 is inter-coded, then the CCM information of block B is obtained by copying CCM information from its referenced block E that is intra-coded in the P/B picture 1520. For still another embodiment, if the reference block in a reference picture is also inter-coded, the CCM information of the reference block is obtained by copying the CCM information from another reference block in another reference picture. For example, as shown in the FIG. 15, the current block C in a current P/B picture 1530 is inter-coded and its referenced block B is also inter-coded, due to the CCM information of block B is obtained by copying the CCM information from block A, then the CCM information of block A is also propagated to the current block C. For still another embodiment, when the current block is inter-coded with bi-directional prediction, if one of its reference blocks is intra-coded and has CCM information, the CCM information of the current block is obtained by copying the CCM information from its intra-coded reference block in a reference picture. For example, suppose block F is inter-coded with bi-prediction and has reference blocks G and H. Block G is intra-coded and has CCM information. The CCM information of block F is obtained by copying the CCM information from the block G coded in CCM mode. For still another embodiment, when the current block is inter-coded with bi-directional prediction, the CCM information of the current block is the combination of the CCM models of its reference blocks (as the method mentioned in section entitled: Inheriting Multiple Cross-Component Models).

In one embodiment, when deriving cross-component models for the current block by using the current luma and chroma reconstruction or prediction samples, if the current derived model error is greater than a threshold, the current derived model is discarded and not stored. For example, the current luma reconstruction samples can be provided to the model and the distortion between the model output and the current chroma reconstruction samples can be calculated. The calculated distortion is then normalized by the current block size or the number of samples used in calculating the distortion. If the normalized distortion is greater than or equal to a threshold, the current derived model is discarded and not stored.

Whether to derive cross-component models for the current block or not can depend on the current block size or area. For example, for small blocks (e.g., block width/height less than or equal to a threshold, or block area less than or equal to a threshold), it is not allowed to derive cross-component models. For another example, for large blocks (e.g., block width/height greater than or equal to a threshold, or block area greater than or equal to a threshold), it is not allowed to derive cross-component models.

In still another embodiment, whether to derive the cross-component models for a block at a neighbouring position of the current block or not can depend on the availability of the reconstruction samples of the current block. For example, the availability of the neighbouring reconstruction samples can be defined by the availability of the reconstructed samples inside the k lines of neighbouring samples. The k can be defined by the IBC neighbouring search region, or the neighbouring buffer area of other intra coding tools (e.g., multi-reference line intra prediction, CCLM or CCCM). If the block at a neighbouring position of the current block is outside the k lines of neighbouring samples of the current block, it will not derive cross-component models for the block at a neighbouring position of the current block.

### Candidate List Construction

In one embodiment, the candidate list is constructed by adding candidates in a pre-defined order until the maximum candidate number is reached. The candidates added may include all or some of the aforementioned candidates, but not limited to the aforementioned candidates. For example, the candidate list may include spatial neighbouring candidates, temporal neighbouring candidates, historical candidates, non-adjacent neighbouring candidates, single model candidates generated based on other inherited models or combined model (as mentioned later in the section entitled: Inheriting multiple cross-component models). For another example, the candidate list can include the same candidates as the previous example, but the candidates are added into the list in a different order.

In another embodiment, if all the pre-defined neighbouring and historical candidates are added but the maximum candidate number is not reached, some default candidates are added into the candidate list until the maximum candidate number is reached.

In one sub-embodiment, the default candidates include, but not limited to, the candidates described below. The final scaling parameter α is from the set

$$\{ 0 , 1 / 8 , - 1 / 8 , + 2 / 8 , - 2 / 8 , + 3 / 8 , - 3 / 8 , + 4 / 8 , - 4 / 8 \} ,$$

and the offset parameter β=1/(1<<bit_depth) or is derived based on neighbouring luma and chroma samples. For example, if the average value of neighbouring luma and chroma samples are lumaAvg and chromaAvg, then β is derived by β=chromaAvg−α·lumaAvg. The average value of neighbouring luma samples (lumaAvg) can be calculated by all selected luma samples, the luma DC mode value the current luma CB, or the average of the maximum and minimum luma samples

$$( e . g . , lumaAvg = ( Max ( {x}_{A}^{0} , {x}_{A}^{1} ) + Min ( {x}_{B}^{0} , {x}_{B}^{1} ) + 1 ) ≫ 1 , or lumaAvg = ( Min ( {x}_{A}^{0} , {x}_{A}^{1} ) + Max ( {x}_{B}^{0} , {x}_{B}^{1} ) + 1 ) ≫ 1 ) .$$

Similarly, average value of neighbouring chroma samples (chromaAvg) can be calculated by all selected chroma samples, the chroma DC mode value the current chroma CB, or the average of the maximum and minimum chroma samples

$$( e . g . , chromaAvg = ( Max ( {y}_{A}^{0} , {y}_{A}^{1} ) + Min ( {y}_{B}^{0} , {y}_{B}^{1} ) + 1 ) ≫ 1 , or chromaAvg = ( Min ( {y}_{A}^{0} , {y}_{A}^{1} ) + Max ( {y}_{B}^{0} , {y}_{B}^{1} ) + 1 ) ≫ 1 ) .$$

In another sub-embodiment, the default candidates include, but not limited to, the candidates described below. The default candidates are α·G+β, where G is the luma sample gradients instead of down-sampled luma samples L. The 16 GLM filters described in the section, entitled Gradient Linear Model (GLM), are applied. The final scaling parameter α is from the set

$$\{ 0 , 1 / 8 , - 1 / 8 , + 2 / 8 , - 2 / 8 , + 3 / 8 , - 3 / 8 , + 4 / 8 , - 4 / 8 \} ,$$

The offset parameter β=1/(1<<bit_depth) or is derived based on neighbouring luma and chroma samples.

In another embodiment, a default candidate can be an earlier candidate with a delta scaling parameter refinement. For example, if the scaling parameter of an earlier candidate is α, the scaling parameter of a default candidate is (α+Δα), where Δα can be a value from the set

$$\{ 1 / 8 , - 1 / 8 , + 2 / 8 , - 2 / 8 , + 3 / 8 , - 3 / 8 , + 4 / 8 , - 4 / 8 \} .$$

And the offset parameter of a default candidate would be derived by (α+Δα) and the average value of neighbouring luma and chroma samples of the current block.

In another embodiment, a default candidate can be a shortcut to indicate a cross-component mode (i.e., using the current neighbouring luma/chroma reconstruction samples to derive cross-component models) rather than inheriting parameters from neighbours. For example, the default candidate can be CCLM_LA, CCLM_L, CCLM_A, MMLM_LA, MMLM_L, MMLM_A, single model CCCM, multiple models CCCM or cross-component model with a specified GLM pattern.

In another embodiment, a default candidate can be a cross-component mode (i.e., using the current neighbouring luma/chroma reconstruction samples to derive cross-component models) rather than inheriting parameters from neighbours, and also with a scaling parameter update (Δα). Then, the scaling parameter of a default candidate is (α+Δα). For example, default candidate can be CCLM_LA, CCLM_L, CCLM_A, MMLM_LA, MMLM_L, or MMLM_A. For another example, Δα can be a value from the set

$$\{ 1 / 8 , - 1 / 8 , + 2 / 8 , - 2 / 8 , + 3 / 8 , - 3 / 8 , + 4 / 8 , - 4 / 8 \} .$$

And the offset parameter of a default candidate will be derived by (α+Δα) and the average value of neighbouring luma and chroma samples of the current block. For still another example, the Da can be different for each colour component.

In another embodiment, a default candidate can be an earlier candidate with partially selected model parameters. For example, suppose an earlier candidate has m parameters, it can choose k out of m parameters from the earlier candidate to be a default candidate, where 0<k<m and m>1.

In another embodiment, a default candidate can be the first model of an earlier MMLM candidate (i.e., the model used when the sample value is less than or equal to classification threshold). In still another embodiment, a default candidate can be the second model of an earlier MMLM candidate (i.e., the model used when the sample value is greater than or equal to classification threshold). In still another embodiment, a default candidate can be the combination of two models of an earlier MMLM candidate. For example, if the models of an earlier MMLM candidate are

$$\{ {c}_{0}^{0} , {c}_{1}^{0} , … , {c}_{M - 1}^{0} \} and \{ {c}_{0}^{1} , {c}_{1}^{1} , … , {c}_{M - 1}^{1} \} .$$

The model parameters of an default candidate can be

$$\{ ( 1 - α ) \times {c}_{0}^{0} + α \times {c}_{0}^{1} , ( 1 - α ) \times {c}_{1}^{0} + α \times {c}_{1}^{1} , … , ( 1 - α ) \times {c}_{M - 1}^{0} + α \times {c}_{M - 1}^{1} \} ,$$

where α is a weighting factor which can be predefined or implicitly derived by neighbouring template cost, and

$${c}_{x}^{y}$$

is the x-th parameter of the y-th model.

In another embodiment, default candidates can be derived from reconstructed samples from non-adjacent neighbouring regions. Let the current block position be at (x, y) and the block size be w×h. If the reconstructed samples in the M×N region located at (x+dx, y+dy) are “available”, the default candidates can be derived using reconstructed luma and chroma samples in the region. For example, M×N can be 8×8. For another example, M×N can be 16×8. For another example, M×N can be 16×16. For another example, M×N can be w×h. The meaning of “available” can be that the reconstructed sample inside the current block is available, or the reconstructed sample inside the k lines of neighbouring samples is available. The k can be defined according to the IBC neighbouring search region, or the neighbouring buffer area of other intra coding tools (e.g., multi-reference line intra prediction, CCLM or CCCM).

In another embodiment, let the current block position be at (x, y) and the block size be w×h, the default candidates can be derived using reconstructed samples in the M×N region located at (x_{mid}+dx, y_{mid}+dy), if the reconstructed samples in the region are available. (x_{mid}, y_{mid})=(x+w/2, y+h/2).

In another embodiment, default candidates derived from reconstructed samples from non-adjacent neighbouring regions can be any type of cross-component model or some particular types of cross-component model. For example, the derived model can be CCLM, MMLM, CCCM, CCCM multi-models, or other cross-component models. For another example, the derived model is CCCM model. For another example, the derived model is CCLM model. For another example, the derive model is CCCM or CCCM multi-models.

In another embodiment, assume two value sets ax and a, are defined as:

αₓ={αₓ₁,αₓ₂,αₓ₃, . . . ,αₓₙ},αₓᵢ<αₓⱼ if i<j

α_{y}={α_{y1},α_{y2},α_{y3}, . . . ,α_{yn}},α_{yi}<α_{yj} if i<j

All values in αₓ and α_{y} are positive numbers. (dx, dy) can be (αₓᵢ×w, −α_{yi}×h), (−αₓᵢ×w, α_{yi}×h), (−αₓᵢ×w, −α_{yi}×h), (αₓᵢ×w, 0), (−αₓᵢ×w, 0), (0, α_{yi}×h), (0, y_{mid}−α_{yi}×h).

In another embodiment, the current block position is at (x, y) and the block size is w×h. Let δx and δy be two fixed positive numbers (dx, dy) can be (αₓᵢ×δx, −α_{yi}×δy), (−αₓᵢ×δx, +α_{yi}×δy), (−αₓᵢ×δx, −α_{yi}×δy), (αₓᵢ×δx, 0), (−αₓᵢ×δx,0),(0,α_{yi}×δy),(0,−α_{yi}×δy).

When constructing a candidate list, candidates are added to the list according to a pre-defined order. For example, the pre-defined order can be spatial adjacent candidates, temporal candidates, spatial non-adjacent candidates, historical candidates, and then default candidates. In one embodiment, if cross-component models are derived for non-LM coded blocks (e.g., as mentioned in the section entitled “Inherit Neighbouring Model Parameters for Refining the Cross-Component Model Parameters”), the candidate models of non-LM coded blocks are added to into the list after candidate models of LM coded blocks are added. In another embodiment, if cross-component models are derived for non-LM coded blocks, the candidate models of non-LM coded blocks are added to the list before default candidates are added. In still another embodiment, if cross-component models are derived for non-LM coded blocks, the candidate models of non-LM coded blocks have lower priority to be added to the list than candidate models for LM coded blocks.

When constructing a candidate list, only the candidate with a certain prediction mode can be added to the list. For example, only the candidates derived by CCLM or MMLM modes can be added to the list. For another example, only the candidates derived by single-model modes (e.g., CCLM, or CCLM with single-model) can be added to the list. For another example, only the candidates derived by multi-model modes (e.g., MMLM, or CCCM with multi-model) can be added to the list. For another example, only the candidates derived by GLM modes can be added to the list. For another example, only the candidates derived by a specific mode (e.g., CCLM, MMLM, CCCM, CCCM with multi-model, or GLM) can be added to the list. In one embodiment, if only the candidate with a certain prediction mode can be added to the list, during prediction mode signalling, it can signal the prediction mode first and then signal if the proposed cross-component merge mode is used or not. If the proposed cross-component merge mode is used, then signal the candidate index.

In the chroma intra fusion mode, a non-CCLM coded intra prediction and a CCLM coded intra prediction are fused together to obtain the final intra prediction. In one embodiment, when inheriting the cross-component model parameters from the block/position coded by a chroma intra fusion mode, the model parameters for obtaining the CCLM coded intra prediction are inherited and further refined. In another embodiment, the fusion weight, the coding mode of non-CCLM coded intra prediction and the model parameters for obtaining the CCLM coded intra prediction are inherited and further refined. In still another embodiment, the coding mode of non-CCLM coded intra prediction is implicitly derived (e.g., derived as DM or planar mode), and the fusion weight and the model parameters for obtaining the CCLM coded intra prediction are inherited and further refined. In still another embodiment, if the non-CCLM coded intra prediction of the block/position coded by the chroma intra fusion mode can be implicitly derived (e.g., the non-CCLM coded intra prediction is DM or planar mode), the fusion weight and the model parameters for obtaining the CCLM coded intra prediction are inherited and further refined.

When constructing a candidate list or a history table, it can further constraint the maximum number of to-be-added candidates with a specific coding mode in the list or table. The specific coding mode here includes, but not limited to, the spatial adjacent/non-adjacent candidates or candidates from history table, the cross-component prediction mode of a candidate (e.g., CCLM, MMLM, CCCM, CCCM with multi-model, or GLM), the intra/inter prediction mode, LM/non-LM prediction mode, the cross-component prediction model of the candidate is inherited from other blocks, or the cross-component prediction model of the candidate is derived from the neighbouring reconstruction samples of the current block.

For example, it can constraint the maximum number of to-be-added spatial adjacent candidates in the candidate list is k₁. For example, it can constraint the maximum number of to-be-added spatial non-adjacent candidates in the candidate list is k₂. For example, it can constraint the maximum to-be-added candidates from a history table in the candidate list is k₃. For example, it can constraint the maximum number of to-be-added candidates with a specific coding mode in the list is k₄. For another example, it can constraint the maximum number of to-be-added candidates have the cross-component prediction model derived from the neighbouring reconstruction samples of the current block in the list is k₅. For the setting of k₁ to k₅, the number is greater than or equal to 1, or depends on the current block size, prediction mode of neighbouring blocks, slice type, temporal identifier, or the maximum allowed candidates of the candidate list.

### Removing or Modifying Similar Neighbouring Model Parameters

When inheriting cross-component model parameters from other blocks, it can further check the similarity between the inherited model and the existing models in the candidate list or those model candidates derived by the neighbouring reconstructed samples of the current block (e.g., models derived by CCLM, MMLM, or CCCM using the neighbouring reconstructed samples of the current block). If the model of a candidate parameter is similar to the existing models, the model will not be added in the candidate list. In one embodiment, it can compare the similarity of (α×lumaAvg+β) or α among existing candidates to decide whether to add the model of a candidate or not. For example, if the (α×lumaAvg+β) or a of the candidate is the same as one of the existing candidates, the model of the candidate is not added. For another example, if the difference of (α×lumaAvg+β) or a between the candidate and one of existing candidates is less than a threshold, the model of the candidate is not added. Besides, the threshold can be adaptive based on coding information (e.g., the current block size or area). For another example, when comparing the similarity, if a model from a candidate and the existing model both use CCCM, it can compare similarity by checking the value of (c₀C+c₁N+c₂S+c₃E+c₄W+c₅P+c₆B) to decide whether to include the model of a candidate or not. In another embodiment, if a candidate position points to a CU which is the same one of the existing candidates, the model of the candidate parameter is not included. In still another embodiment, if the model of a candidate is similar to one of the existing candidate models, it can adjust the inherited model parameters so that the inherited model is different from the existing candidate models. For example, if the inherited scaling parameter is similar to one of the existing candidate models, the inherited scaling parameter can add a predefined offset (e.g., 1>>S or −(1>>S), where S is the shift parameter) so that the inherited parameter is different from the existing candidate models.

In another embodiment, it only compares partial model parameters with the existing models in the candidate list. For example, a CCLM candidate has a scale and offset parameters, it only compares if the scale or offset parameters is the same or similar to existing candidates or not. If the scale or offset parameter is the same or similar, the model will not be added to the candidate list. For another example, a CCCM candidate has c₀ to c₆ parameters, it can only compare if n parameters (n<7) are the same or similar with existing candidates or not. If the scale or offset parameters is the same or similar, the model will not be added to the candidate list.

In another embodiment, it can apply a candidate model to the neighbouring reconstruction samples of the current block, and compare the difference with the existing candidate models. If the difference value is less than or equal to a threshold, the model will not be added to the candidate list. For example, assume the applied result is

$${p}_{j}^{nei}$$

and the corresponding results of the existing models in the candidate list are

$${p}_{0}^{nei} to {p}_{i}^{nei} . If \vert {p}_{j}^{nei} - {p}_{0}^{nei} \vert < th ,$$

$$\vert {p}_{j}^{nei} - {p}_{1}^{nei} \vert < th , … , or \vert {p}_{j}^{nei} - {p}_{i}^{nei} \vert < th ,$$

the model will not be added to the candidate list. For the selection of the neighbouring reconstruction samples, it can choose the neighbouring reconstruction sample with the maximal value, the neighbouring reconstruction sample with the minimal value, the mean/median/mode of the neighbouring reconstruction samples, the left-side neighbouring reconstruction samples, the above-side neighbouring reconstruction samples, or the above-left neighbouring reconstruction samples.

In another embodiment, the number of candidates with the same type (e.g., MMLM, CCCM, or GLM) is limited when adding the candidates to the list. For example, if the current list has k candidates with MMLM type, it is not allowed to further add candidates with MMLM type to the list. For another example, if the current list has k candidates with CCCM type, it is not allowed to further add candidates with CCCM type to the list. For another example, if the current list has k candidates with GLM type, it is not allowed to further add candidates with GLM type to the list.

In another embodiment, default candidates will not compare with the existing models in the candidate list and will be added to the candidate list.

### Reordering the Candidates in the List

The candidates in the list can be reordered to reduce the syntax overhead when signalling the selected candidate index. The reordering rules can depend on the coding information of neighbouring blocks or the model error. For example, if neighbouring above or left blocks are coded by MMLM, the MMLM candidates in the list can be moved to the head of the current list. Similarly, if neighbouring above or left blocks are coded by single model LM or CCCM, the single model LM or CCCM candidates in the list can be moved to the head of the current list. Similarly, if GLM is used by neighbouring above or left blocks, the GLM related candidates in the list can be moved to the head of the current list.

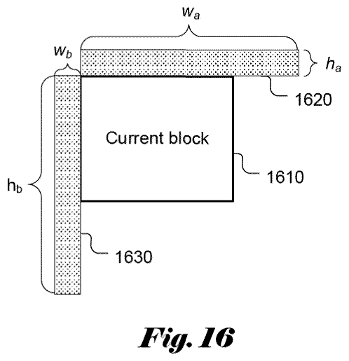

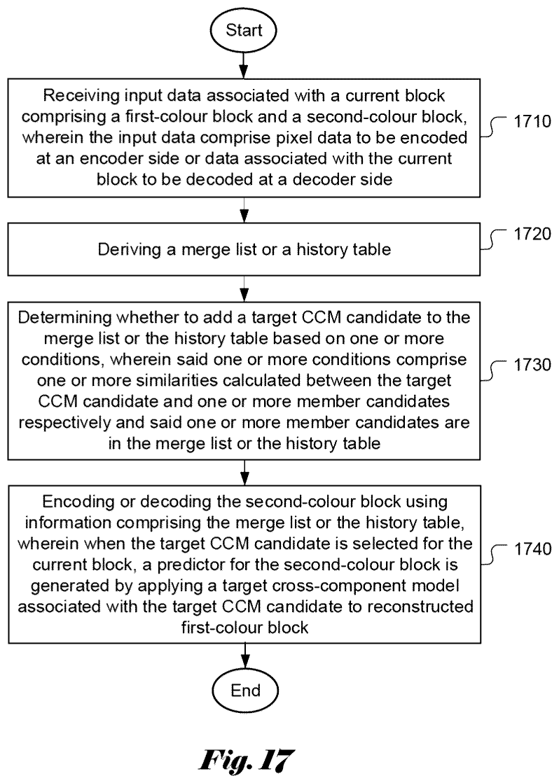

In still another embodiment, the reordering rule is based on the model error by applying the candidate model to the neighbouring templates of the current block, and then comparing the error with the reconstructed samples of the neighbouring template. For example, as shown in FIG. 16, the size of the above neighbouring template 1620 of the current block is wₐ×hₐ, and the size of left neighbouring template 1630 of the current block 1610 is w_{b}×h_{b}. Suppose K models are in the current candidate list, and αₖ and βₖ are the final scale and offset parameters after inheriting the candidate k. The model error of candidate k corresponding to the above neighbouring template is:

$${e}_{a}^{k} = {\sum }_{i , j} \vert ( {α}_{k} \times {recL}^{′} \begin{matrix}( i , j ) \\ a\end{matrix} + {β}_{k} ) - {recC}_{a}^{( i , j )} \vert$$

$$where , {recL}^{′} \begin{matrix}( i , j ) \\ a\end{matrix} and {recC}_{a}^{( i , j )}$$

are the reconstructed samples of luma (e.g., after downsampling process or after applying GLM pattern) and reconstructed samples of chroma at position (i,j) in the above template, and 0≤i<wₐ and 0≤j<hₐ.

Similarly, the model error of candidate k by the left neighbouring template is:

$${e}_{b}^{k} = {\sum }_{m , n} \vert ( {α}_{k} \times {recL}^{′} \begin{matrix}( m , n ) \\ b\end{matrix} + {β}_{k} ) - {recC}_{b}^{( m , n )} \vert$$

$$where {recL}^{′} \begin{matrix}( m , n ) \\ b\end{matrix} and {recC}_{b}^{( m , n )}$$

are the reconstructed samples of luma (e.g., after applying downsampling process or GLM pattern) and reconstructed samples of chroma at position (m, n) in the left template, and 0≤m<w_{b} and 0≤n<h_{b}.

Then the model error of candidate k is:

$${e}^{k} = {e}_{a}^{k} + {e}_{b}^{k}$$

After calculating the model error among all candidates, it can get a model error list E={e⁰, e¹, e², . . . , e^{k}, . . . , e^{K}}. Then, it can reorder the candidate index in the inherited candidate list by sorting the model error list in ascending order.

In still another embodiment, if the candidate k uses CCCM prediction, the

$${e}_{a}^{k} and {e}_{b}^{k}$$

are defined as:

$${e}_{a}^{k} = {\sum }_{i , j} \vert ( c {0}_{k} \times {recL}^{′} \begin{matrix}( i , j ) \\ a\end{matrix} + c {1}_{k} \times {recL}^{′} \begin{matrix}( i , j - 1 ) \\ a\end{matrix} + c {2}_{k} \times {recL}^{′} \begin{matrix}( i , j + 1 ) \\ a\end{matrix} + c {3}_{k} \times {recL}^{′} \begin{matrix}( i - 1 , j ) \\ a\end{matrix} + c {4}_{k} \times {recL}^{′} \begin{matrix}( i + 1 , j ) \\ a\end{matrix} + c {5}_{k} \times P + c {6}_{k} \times B ) - {recC}_{a}^{( i , j )} \vert$$

$${e}_{b}^{k} = {\sum }_{i , j} \vert ( c {0}_{k} \times {recL}^{′} \begin{matrix}( i , j ) \\ b\end{matrix} + c {1}_{k} \times {recL}^{′} \begin{matrix}( i , j - 1 ) \\ b\end{matrix} + c {2}_{k} \times {recL}^{′} \begin{matrix}( i , j + 1 ) \\ b\end{matrix} + c {3}_{k} \times {recL}^{′} \begin{matrix}( i - 1 , j ) \\ b\end{matrix} + c {4}_{k} \times {recL}^{′} \begin{matrix}( i + 1 , j ) \\ b\end{matrix} + c {5}_{k} \times P + c {6}_{k} \times B ) - {recC}_{b}^{( i , j )} \vert$$

where c0ₖ, c1ₖ, c2ₖ, c3ₖ, c4ₖ, c5ₖ, and c6ₖ are the final filtering coefficients after inheriting the candidate k. P and B are the nonlinear term and bias term.

In still another embodiment, if the above neighbouring template is not available, then

$${e}^{k} = {e}_{b}^{k} .$$

Similarly, if the left neighbouring template is not available, then

$${e}^{k} = {e}_{a}^{k} .$$

If both templates are not available, the candidate index reordering method using model error is not applied.

In still another embodiment, not all positions inside the above and left neighbouring template are used in calculating model error. It can choose partial positions inside the above and left neighbouring template to calculate the model error. For example, it can define a first start position and a first subsampling interval depending on the width of the current block to partially select positions inside the above neighbouring template. Similarly, it can define a second start position and a second subsampling interval depending on the height of the current block to partially select positions inside the left neighbouring template. For another example, hₐ or h_{b} can be a constant value (e.g., hₐ or h_{b} can be 1, 2, 3, 4, 5, or 6). For another example, hₐ or h_{b} can be dependent on the block size. If the current block size is greater than or equal to a threshold, hₐ or h_{b} is equal to a first value. Otherwise, hₐ or h_{b} is equal to a second value.

In still another embodiment, the candidates of different types are reordered separately before the candidates are added into the final candidate list. For each type of the candidates, the candidates are added into a primary candidate list with a pre-defined size N₁. The candidates in the primary list are reordered. The candidates (N₂) with the smallest costs are then added into the final candidate list, where N₂≤N₁. In another embodiment, the candidates are categorized into different types based on the source of the candidates, including but not limited to the spatial neighbouring models, temporal neighbouring models, non-adjacent spatial neighbouring models, and the historical candidates. In another embodiment, the candidates are categorized into different types based on the cross-component model mode. For example, the types can be CCLM, MMLM, CCCM, and CCCM multi-model. For another example, the types can be GLM-non active or GLM active.

In still another embodiment, after the candidates are reordered based on the template cost, the redundancy of the candidate can be further checked. A candidate is considered to be redundant if the template cost difference between it and its predecessor in the list is less than or equal to a threshold. If a candidate is considered redundant, it can be removed from the list, or it can be moved to the end of the list.

In still another embodiment, the candidates allowed or not allowed to do reordering can depend on the model type or coding mode. The model type or coding mode specified here includes, but not limited to the spatial adjacent/non-adjacent candidates or candidates from history table, the intra/inter prediction mode, LM/non-LM prediction mode, the cross-component prediction mode of a candidate (e.g., CCLM, MMLM, CCCM, or CCCM with multi-model, or GLM), the cross-component prediction model of the candidate is inherited from other blocks, or the cross-component prediction model of the candidate is derived from the neighbouring reconstruction samples of the current block. For example, the spatial adjacent candidates of the current block in the candidate list are reordered. For another example, the spatial non-adjacent candidates of the current block in the candidate list are reordered. For another example, the candidates from history table in the candidate list are reordered. For another example, the spatial adjacent candidates and spatial non-adjacent candidates of the current block in the candidate list are reordered. For another example, the candidates with specific model type or coding mode are self-reordered and not reordered with other model types or coding modes.

For another example, the candidates with the cross-component prediction model derived from the neighbouring reconstruction samples of the current block are not reordered. For another example, if a candidate is not allowed to do reordering, the position of the candidate in the list is not changed before and after the candidate list reordering.

Removing or Modifying Similar Model Parameters when Adding Candidates to a History Table

When adding cross-component model to a history table, it may further check the similarity between the to-be-added model and the existing models in the history table. If the to-be-added model is similar to one of the existing models, the to-be-added model will not be added to the history table. In one embodiment, it may compare the similarity of (α×lumaAvg+β) or a among existing candidates to decide whether to add the to-be-added model or not. For example, if the (α×lumaAvg+β) or a of the to-be-added model is the same as one of the existing candidates, the to-be-added model is not added. For another example, if the difference of (α×lumaAvg+β) or a between the to-be-added model and one of existing models is less than a threshold, the to-be-added model is not added. Besides, the threshold can be adaptive based on coding information (e.g., the current block size or area). For another example, when comparing the similarity if a to-be-added model and the existing model both use CCCM, it may compare similarity by checking the value of (c₀C+c₁N+c₂S+c₃E+c₄W+c₅P+c₆B) to decide whether to add the to-be-added model or not. In another embodiment, if the CU position of the current to-be-added model is the same CU position of the existing candidates, the to-be-added model parameter is not added. In still another embodiment, if the to-be-added model is similar to one of existing candidate models, it may adjust the inherited model parameters to let the to-be-added model to be different from the existing candidate models. For example, if the to-be-added scaling parameter is similar to one of existing candidate models, the to-be-added scaling parameter may add a predefined offset (e.g., 1 S or -(1 S), where S is the shift parameter) to let the to-be-added model is different from the existing candidate models.

In another embodiment, only partial model parameters are compared with the existing models in the history table. For example, a CCLM candidate has a scale and offset parameters, it only compares if the scale or offset parameters are the same or similar with existing candidates or not. If the scale or offset parameters are the same or similar, the to-be-added model will not be added to the history table. For another example, a CCCM candidate has c₀ to c₆ parameters, it may only compare if n parameters (n<7) are the same or similar with existing candidates or not. If the scale or offset parameters is the same or similar, the to-be-added model will not be added to the history table.

In another embodiment, a to-be-added model is applied to the neighbouring reconstruction samples of the current block, and the difference with the existing candidate models is compared. If the difference value is less than or equal to a threshold, the to-be-added model will not be added to the history table. For example, assume the applied result is

$${p}_{j}^{nei}$$

and the corresponding results of the existing models in the history table are

$${p}_{0}^{nei} to {p}_{i}^{nei} . If \vert {p}_{j}^{nei} - {p}_{0}^{nei} \vert < th ,$$

$$\vert {p}_{j}^{nei} - {p}_{1}^{nei} \vert < th , … , or \vert {p}_{j}^{nei} - {p}_{i}^{nei} \vert < th ,$$

the to-be-added model will not be added to the history table. For the selection of the neighbouring reconstruction samples, it may choose the neighbouring reconstruction sample with the maximal value, the neighbouring reconstruction sample with the minimal value, the mean/median/mode of the neighbouring reconstruction samples, the left-side neighbouring reconstruction samples, the above-side neighbouring reconstruction samples, or the above-left neighbouring reconstruction samples.

In another embodiment, the number of candidates having the same type (e.g., MMLM, CCCM, or GLM) is limited when adding the candidates to the history table. For example, if the current history table has k candidates with MMLM type, it is not allowed to further add candidates with MMLM type to the history table. For another example, if the current history table has k candidates with CCCM type, it is not allowed to further add candidates with CCCM type to the history table. For another example, if the current history table has k candidates with GLM type, it is not allowed to further add candidates with GLM type to the history table.

In another embodiment, the constraints or rules to prevent adding a redundant candidate to a history table will share/be the same as that of preventing adding a redundant candidate into a candidate list (e.g., the constraints or rules mentioned in the section entitled “Remove or Modify Similar Neighbouring Model Parameters).

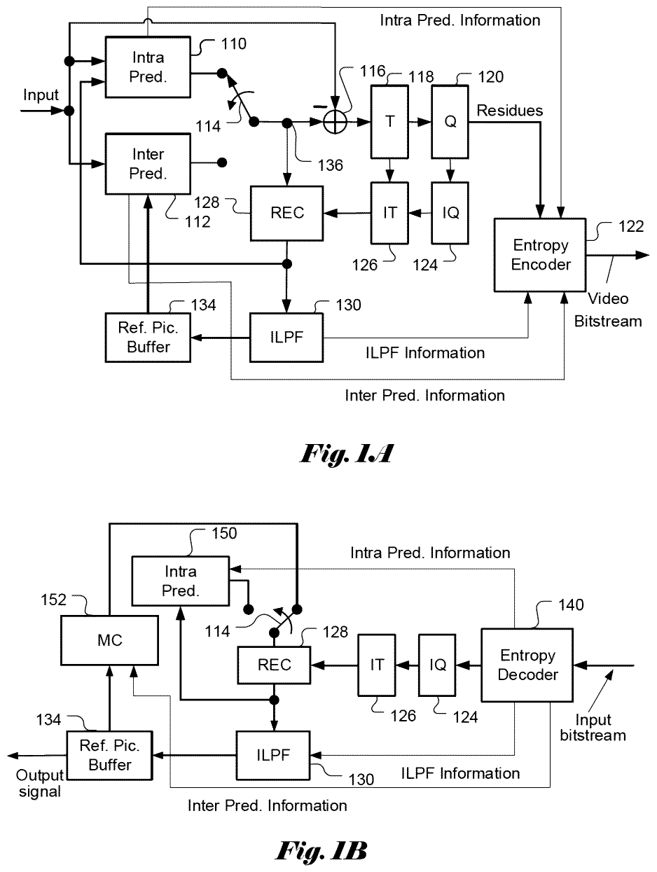

The method and apparatus for adding cross-component model candidates to a history table of merge list based on similarity can be implemented in an encoder side or a decoder side. For example, any of the proposed method can be implemented in an Intra/Inter coding module (e.g. Intra Pred. 150/MC 152 in FIG. 1B) in a decoder or an Intra/Inter coding module in an encoder (e.g. Intra Pred. 110/Inter Pred. 112 in FIG. 1A). Any of the proposed method can also be implemented as a circuit coupled to the intra/inter coding module at the decoder or the encoder. However, the decoder or encoder may also use additional processing unit to implement the required processing. While the Intra Pred. units (e.g. unit 110/112 in FIG. 1A and unit 150/152 in FIG. 1B) are shown as individual processing units, they may correspond to executable software or firmware codes stored on a media, such as hard disk or flash memory, for a CPU (Central Processing Unit) or programmable devices (e.g. DSP (Digital Signal Processor) or FPGA (Field Programmable Gate Array)).

FIG. 17 illustrates a flowchart of an exemplary video coding system that adds a cross-component model candidate to a history table of merge list based on similarity according to an embodiment of the present invention. The steps shown in the flowchart may be implemented as program codes executable on one or more processors (e.g., one or more CPUs) at the encoder side. The steps shown in the flowchart may also be implemented based on hardware such as one or more electronic devices or processors arranged to perform the steps in the flowchart. According to the method, input data associated with a current block comprising a first-colour block and a second-colour block are received in step 1710, wherein the input data comprise pixel data to be encoded at an encoder side or data associated with the current block to be decoded at a decoder side. A merge list or a history table is derived in step 1720. Whether to add a target CCM (Cross Component Model) candidate to the merge list or the history table is determined based on one or more conditions in step 1730, wherein said one or more conditions comprise one or more similarities calculated between the target CCM candidate and one or more member candidates respectively, and said one or more member candidates are in the merge list or the history table. The second-colour block is encoded or decoded using information comprising the merge list or the history table in step 1740, wherein when the CCM candidate is selected for the current block, a predictor for the second-colour block is generated by applying a target cross-component model associated with the CCM candidate to reconstructed first-colour block.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of coding colour pictures using coding tools including one or more cross component models related modes, the method comprising:
receiving input data associated with a current block comprising a first-colour block and a second-colour block, wherein the input data comprise pixel data to be encoded at an encoder side or data associated with the current block to be decoded at a decoder side;
deriving a merge list or a history table;
determining whether to add a target CCM (Cross Component Model) candidate to the merge list or the history table based on one or more conditions, wherein said one or more conditions comprise one or more similarities calculated between the target CCM candidate and one or more member candidates respectively, and said one or more member candidates are in the merge list or the history table; and
encoding or decoding the second-colour block using information comprising the merge list or the history table, wherein when the target CCM candidate is selected for the current block, a predictor for the second-colour block is generated by applying a target cross-component model associated with the target CCM candidate to reconstructed first-colour block.

2. The method of claim 1, wherein said one or more similarities are calculated based on one or more model parameters.

3. The method of claim 2, wherein part of said one or more model parameters are used for calculating said one or more similarities.

4. The method of claim 3, wherein the target CCM candidate corresponds to a CCLM candidate with a scale and one or more offset parameters, and said one or more similarities are measured based on the scale or based on said one or more offset parameters.

5. The method of claim 3, wherein the target CCM candidate corresponds to a CCCM candidate with c0 to c6 parameters, and said one or more similarities are measured based on only n parameters and n is less than 7.

6. The method of claim 1, wherein said one or more similarities are calculated based on one or more model errors.

7. The method of claim 6, wherein the target cross-component model associated with the target CCM candidate is applied to neighbouring reconstructed first-colour samples of the current block to derive a target model error associated with the CCM candidate, and the target model error is compared with one or more member model errors associated with said one or more member candidates.

8. The method of claim 1, wherein a maximum number of to-be-added candidates associated with a specific coding mode in the merge list or the history table is constrained to be k, and the k is a positive integer.

9. The method of claim 8, wherein the to-be-added candidates associated with the specific coding mode correspond to spatial adjacent candidates or the to-be-added candidates with the specific coding mode correspond to non-spatial adjacent candidates.

10. The method of claim 8, wherein the to-be-added candidates associated with the specific coding mode are from the history table.

11. The method of claim 8, wherein the to-be-added candidates associated with the specific coding mode have a cross-component prediction model derived from neighbouring reconstruction samples of the current block.

12. The method of claim 8, wherein the k depends on current block size, prediction mode of one or more neighbouring blocks, slice type, temporal identifier, maximum allowed number of said one or more member candidates, or a combination thereof.

13. The method of claim 1, wherein whether said one or more member candidates are allowed to be reordered or not depends on a model type or coding mode associated with said one or more member candidates.

14. The method of claim 13, wherein when said one or more member candidates correspond to spatial adjacent candidates or said one or more member candidates correspond to non-spatial adjacent candidates, said one or more member candidates are allowed to be reordered.

15. The method of claim 13, wherein when said one or more member candidates correspond to spatial adjacent candidates or non-spatial adjacent candidates, said one or more member candidates are allowed to be reordered.

16. The method of claim 13, wherein when said one or more member candidates are from the history table, said one or more member candidates are allowed to be reordered.

17. The method of claim 13, wherein when said one or more member candidates are associated with a cross-component prediction model derived from neighbouring reconstruction samples of the current block, said one or more member candidates are not allowed to be reordered.

18. An apparatus for video coding, the apparatus comprising one or more electronics or processors arranged to:
receive input data associated with a current block comprising a first-colour block and a second-colour block, wherein the input data comprise pixel data to be encoded at an encoder side or data associated with the current block to be decoded at a decoder side;
derive a merge list or a history table;
determine whether to add a target CCM (Cross Component Model) candidate to the merge list or the history table based on one or more conditions, wherein said one or more conditions comprise one or more similarities calculated between the target CCM candidate and one or more member candidates respectively, and said one or more member candidates are in the merge list or the history table; and
encode or decode the second-colour block using information comprising the merge list or the history table, wherein when the target CCM candidate is selected for the current block, a predictor for the second-colour block is generated by applying a target cross-component model associated with the target CCM candidate to reconstructed first-colour block.
